(19) United States
(12) Patent Application Publication
(10) Pub. No.: US 2019/0303411 A1
(43) Pub. Date: Oct. 3, 2019

(54) Pixmap Forms System and Method

(71) Applicant: Eric Cameron Wilson, Benloch (AU)

(72) Inventors: Eric Cameron Wilson, Benloch (AU); Daniel Lawrence Wilson, Romsey (AU)

(73) Assignee: DocBlaster Pty Ltd, Benloch (AU)

(21) Appl. No.: 16/372,971

(22) Filed: Apr. 2, 2019

(30) Foreign Application Priority Data
Apr. 2, 2018 (AU) AU2018901474
Oct. 30, 2018 (AU) AU2018904109
Nov. 22, 2018 (AU) AU2018904450

(51) Int. Cl. G06F 16/93; G06F 16/958; G06K 9/00

(52) U.S. Cl. CPC G06F 16/93; G06K 9/00449; G06F 16/958

(57) ABSTRACT

A composite document is scanned for the existence of fields or placeholders or other information input areas, so that their disposition within the composite document and other properties, are collated. Object placeholders (which might be a rectangle object for example) may then replace fields or placeholders or information input areas within in the document. This is to suitably create “whitespace” for an equivalent appropriate field, control or widget to be rendered in that space such as in a Web presentation. After this, the composite document is rasterised to create one or more pixmap pages. The pixmaps are then sent to a user device via a computer network for display in a program such as a Web browser, along with any properties relating to the fields, placeholders or other information input areas that were detected in the composite document. The properties may be used to accurately overlay online fields, controls or widgets corresponding to the areas reserved by the object placeholders during the page(s) rasterisation. Periodically, these overlaid field(s), control(s) or widget(s) are checked for changes made by an end user or a verification, validation or other process. If a change has occurred the data is provided to update the composite document, or meld it into or replace portions of a pixmap, in order to create a new pixmap(s) screen page with the updated information represented within it. The updated pixmap(s) is then displayed on the end user device for approval. If the end user approves, that final pixmap(s) is considered the authoritative record for archive. The agreed pixmap-based pages may also be collated into a PDF file where property data may also be preserved as annotations.

### BACKGROUND

The field of the invention lies in computer-assisted information presentation and editing and recordation.

Electronic information that is intended to be modified by programs is typically stored in coded form, such as text, fonts or graphical format files. Long-time examples of these include text (e.g. Unicode, 1991), true type (“TTF”, 1991), and Vector Graphics Language (“VML” 1998, W3C NOTE-19980153). These are often combined to form composite documents such as Hypertext Markup Language (HTML), Portable Document Format (PDF) or word processor files (eg DOC, ODF), scalable vector graphics (“SVG”, 2001, W3C Scalable Vector Graphics (SVG) 1.0 Specification) format or Experimental Computing Facility (“XCF”, 2006, Partial Specification of the XCF Format) format. Information displayed on screen may also be dynamically generated by scripting programs such as JavaScript.

All these forms of information require end user programs to interpret them in order to print or display, which introduces the possibility of differences between how the same information may be rendered by different computer systems. Web browsers for example, are notorious for variations in the way Web pages are rendered, so that designers must often create different versions of information to display correctly on different systems. While PDF provides more control from a design standpoint, different PDF viewers support the PDF format to different extents. Likewise different devices may have different fonts installed.

The inability to guarantee how a document will look on end-users' devices has implications for contract formation when agreement is reached using electronic means. There have been cases where contracts have been unenforceable because end users could not be expected to see the contract clearly. Nevertheless, online contract formation is now becoming more popular with signing apps, even on mobile devices, where users are never expected to print the contract before signing. This means it a party presenting a contract may be more obliged to ensure it is readable on screen and to be able to prove that it was. Indeed contracts may never be signed if they are unreadable.

Only raster based graphics—pixmaps—can be relied on to display in a highly consistent way between computer systems. An example of this is the TIFF or PNG formats. But these are not readily editable from a textural, tabular and graphical informational standpoint. For example, they can't be “filled in” as a contract should be.

So when a person enters their name into an online form for example, this goes into a text field. When they sign a document using a touch-screen, the digitized signature is stored as a separate image. The writing on the page may use characters and fonts. These may then be combined into a composite document such as Web page or a PDF representation of what was displayed in a Web page. However, this means information can be lost in the translation between different formats. And the argument can always be made that what was shown on screen to one party was not as clear as the version that was stored on a server.

Differences in screen sizes and the problems with information technology described above, mean the differences in the legibility of a document shown on a mobile phone compared with when created on a desktop PC may be significant. Indeed, if a dispute arises years after the contract was formed, the devices used to form it may no longer be in the possession of the parties. In the case of Web-based presentation or signing technologies, even recreating the server systems as they were at the time of contract formation or information presentation to enable the creation of a reconstruction can be prohibitively expensive.

So in a dispute, it would be an advantage for a judge to have an exact copy of information as it was presented for signing to each party, not a server-side reconstruction of it. This is particularly problematic where a party is expected to sign online and their signature is digitized, since the digitized signature proving intent forms part of the reconstruction. As no ink sinks into paper or parchment, there may be probable doubt that what is presented in court is exactly what was seen on screen at the time of contract formation or information disclosure.

Some online signing or data room solutions try to minimise the problems by presenting the contract or information as a series of rasterised screen pages. Custom information, such as names, dates and digitised signatures may be appended to this and presented afterwards as a single PDF file. Alternatively, the presentation to end users may be rasterised on a server with any changes end users make being laid over the top (“overlaid”) of the rasterised information. Both these concepts still rely on the reconstruction principle for the custom information end users have provided—there's no ink soaked into the parchment so to speak to form a single piece of data. However at least in the former case, the main body of information being agreed to by parties or informing parties is not subsequently reconstructed for archival purposes. The trouble is, people like filling in forms in context and in particular, reviewing the information they have entered in context. Likewise, being able to tick that a section was read requires it to appear next to what was read.

What is needed is a means of having non-reconstructed information presentation that is still editable by end users, so parties may have exact copies of what was shown and/or signed.

### BRIEF DESCRIPTION

It is an object of the invention to facilitate better electronic information handling by providing both editability and a non-reconstruction of information. Further or alternatively, it is an object of the invention to improve the reliability of IT archives by providing exact copies of what was presented and entered on screen. Further or alternatively, it is an object of the invention to improve computer-assisted information presentation and editing and recordation, to, by and for humans respectively. Further objects may be found in the following description:

In this specification: An end user device (“device”) is a computer with a display, one or more CPUs, memory and input/output means, such as a PC, cell phone, tablet, TV set-top box, games console, watch and the like, typically without a printer. A server could 100 be a web server or other server capable of running program(s) in conjunction with program(s) on an end user device being connected via a computer network such as the Internet. Without limitation, a composite document is an electronic document which may contain text, controls or graphical information or any combination of these. (A composite document is not a “flat” image or collation or collection of flat images.)

A brief overview of the invention is now provided to aid understanding rather than necessarily limit the invention. In preference, this following work is done using computer program(s) running on one or more servers connected to a computer network: A composite document is scanned for the existence of fields or placeholders or other information input areas, so that their disposition within the composite document and other properties, are collated. Object placeholders (which might be a rectangle object for example) may then replace fields or placeholders or information input areas within in the document. This is to suitably create “whitespace” for an equivalent appropriate control or widget to be rendered in that space such as in a Web presentation. For example, the field “Date: ______” might be replaced by an object placeholder with enough room for a date picker widget to be rendered, which being larger, would cause the document to be re-flowed. After this, the composite document is rasterised to create one or more pixmap pages.

The pixmaps are then sent to a user device via a computer network for display in a program such as a Web browser, along with any properties relating to the fields, placeholders or other information input areas that were detected in the composite document. The properties may be used to accurately overlay online fields, controls or widgets corresponding to the areas reserved by the object placeholders during the page(s) rasterisation. Periodically, these overlaid field(s), control(s) or widget(s) are checked changes by an end user or a verification, validation or other process. If a change has occurred the data is provided (in preference to a server) to update the composite document, or meld it into or replace portions of a pixmap, in order to create a new pixmap(s) screen page with the updated information represented within it. The updated pixmap(s) is then (in preference sent from the server and) displayed on the end user device for approval. If the end user approves, that final pixmap(s) is considered the authoritative record which may be transferred via a computer network and archived as appropriate. For convenience, the agreed pixmap-based pages may be collated into a PDF file where property data may also be preserved as annotations.

It will be appreciated that a “flat” image or collation or collection of images not suitable for input into the invention may be scanned to recognise any text controls or graphical information represented in them, to create a composite document suitable for input into the invention.

While the invention as described works well for information that has been formatted into pages by its author, problems may arise with un-paginated content, such as an email or ordinary Web page. This is because groups of associated controls, such as radio buttons, may be interrupted by page breaks when paginated. Therefore in a a preferred embodiment, where a page break falls between a group of associated input fields, the plurality of pages upon which the fields appear may be presented as a scrolling one after another and approved singly as a group. Further or alternatively, a sufficient or variable-length pagination process may be triggered during the composite document scanning process, to ensure associated groups of fields, placeholders or data entry controls are accommodated on the same page. In another embodiment, a user may be notified when associated controls span several pages. This notification may be inserted into the document such as “More options on the next page . . . ” message appearing at the bottom of a screen page pixmap. In the case where an end-user changes a control on one page which affects another on another page, the pixmaps of both pages may be updated and presented to the end-user to approve the change.

It will be appreciated that information that has been agreed to by end users using the invention might also be made available in traditional IT formats such as JSON, XML or HTML.

### DESCRIPTION

In one form, although it may not be the only intended or indeed the broadest form, the invention resides in a system comprising at least one or more of each of the following:
(a) an end user device means on which a user may operate a program which displays information and is capable of taking input such as voice commands, text and or touch screen input; and
(b) a composite document containing fields which require filling or a placeholder or indicator of where data belongs such as date(s) or signature(s) or graphic(s) placeholder(s); and
(c) an end-user service program running on a server which provides screen images to an end user device means and accepts requests from an end user device means via a network; and
(d) a rasteriser-analyser service program running on a server which:
   (i) analyses page(s) of said composite document to find the disposition of input fields or placeholders on each page, and records their properties; then
   (ii) in preference, substitutes or uses object placeholders (preferably invisible) in place of input placeholders or fields into said page(s) (and optionally reflowing said composite document such as for clarity or to ensure information is not obscured by an object placeholder) to reserve space appropriate for overlaying any controls or widgets over screen pages representing the composite document on said end user device; then
   (iii) rasterises page(s) of said composite document to create a pixmap “screen page” of each, in preference with said input placeholders or object placeholders not being visible;
wherein said pixmap(s) are accessed by said user service and provided to the device means for display to said end user;
wherein said page property records are accessed by said user service to create one or more of fields or controls appropriate to any placeholders, to overlay upon said pixmap(s) displayed on the display device means;
wherein if said overlaid field(s) or said overlaid control(s) have been modified with end user data, and optionally if said end user so requests, said modified data is communicated to said rasteriser-analyser so that the composite document is updated with said modified data and a new rasterisation is made and the resulting new pixmap is communicated back to said end user device means and displayed there to be approved by the said end user;
wherein said field(s)/control(s) may be re-overlaid to enable the said end user to make correction(s);
wherein if said approval is given by user (such as by an ‘Approved’ button or voice command), the said pixmap is stored and the next pixmap page is presented on end user device means.
In a preferred embodiment, the updating of the analyser-rasteriser with end-user data may be automatic when all the overlaid fields/controls have been provided with end-user data. Further or alternatively, the updating may be progressive end-user data is provided if network speed is sufficient or the size of the pixmap involved is relatively small or both.
It will be appreciated the end user service and the rasteriser-analyser service may be combined or the analysing of composite documents may be performed separately from rasterisation, depending on how the system is to be implemented.
Further, in alternative embodiments, the said server or elements of said server may reside on the end user device, with said approved pixmaps being communicated via a computer network to another server.
It will be appreciated that a placeholder may also contain a link to content to be inserted when a composite document is loaded or when information is viewed.
In another form, and turning to FIG. 1 as an example, the invention consists of a method with the steps of:
   (1) Obtaining a composite document 101 containing field(s) or placeholder(s) for data input control(s) such as signature panels, date pickers or other input widgets, or both field(s) and placeholder(s); then
   (2) analysing 102 page(s) of said composite document 101 to find the disposition of input fields or placeholders on each page and recording properties 103 (e.g. image map(s) and other information) of these; then
   (3) substituting 104 any object placeholders for corresponding to input placeholders or fields into pages of said composite document 101, and optionally, reflowing said composite document to thus provide space appropriate for rendering widgets on an end user device means corresponding to said object placeholders;
(4) also rasterising 105 each page of said composite document 101 to create a pixmap of each, in preference with said input fields or placeholders or object placeholders not being visible; then
(5) providing copies 106 of said pixmap pages(s) and said properties for display on a device means to end user; then
(6) using said properties to create one or more of field or control widgets 107 appropriate to any object placeholders 108, to overlay upon said pixmap(s) to be displayed on the display device means; then
(7) checking (such as at the request of the said end user 110 or when a field or control or widget loses focus for example or when another end user has updated a field or control or widget) to see if any data in said overlaid field(s) or said overlaid control(s) has been modified on a display device means 111; then
(8) updating said composite document with any modified data, and re-rasterising to create an updated pixmap, and if performed on the said server copying said updated pixmap to said end user device means 111 otherwise copying it to a server (e.g. via a computer network); then
(9) displaying copy of any updated pixmap(s) 112 on said end user device means 111 to be approved by said end user (such as by pressing an ‘Approved’ button 113 for example); then
(10) re-overlaying any said field(s)/control(s) 107 if the corresponding area(s) is selected by said end user to enable that end user to make correction(s), and going to step 7; then
(12) if said approval 113 is given by said user, storing approved pixmaps 114 and other data, and displaying the next pixmap on end user device means, if available. (Likewise end users may suitably navigate to next or previous pixmaps if available.)

It will be appreciated the first three steps may be performed once for many users as a composite document pre-process. It will also be appreciated that the modification of data in overlaid field(s) or control(s) may be periodically triggered or triggered by an event such as the data's entry or the user navigating to the next pixmap page by means of a “next button”, for example.

In a preferred embodiment, the said analysing, rasterising re-rasterising and providing copies of pixmaps steps are performed on a server 100. Alternatively, some or all of these steps may be performed on an end user device means with exact copies of approved pixmap(s) sent to the server, in which case there may be no need to copy pixmap(s) to said end user device means.

The benefit of having an approvals process 113 for each pixmap is that the end user has verified the accuracy of the updated pixmap page as non-reconstructed information, an identical copy of which is kept on the server. In a preferred embodiment, before the user is able to approve, checks are made that the updated pixmap page loaded correctly. Without limitation, such checks may be done by way of checksums on pixmap files or by checking the last row of pixels that they arrived.

It will also be appreciated of the said re-overlaying aspect of the invention that it is optional, and that the approval mechanism is in this case made inaccessible and the scanning process will occur when a submit button is pressed or the end user navigates to the next page (or a button-press acting in both capacities) for example. (Likewise end users may navigate to a previous screen page(s) of pixmap(s) if available.)

It is to be understood that said displaying the next pixmap is optional, such as where a sequence of pixmaps occurs in which those following those on the said end user's display are undisplayed.

It should also be understood that if several pixmaps are displayed on an end user device means one approval given by a said end user may approve all those updated pixmaps which are displayed.

It will be appreciated that a control (such as a button or combo box for example) within an composite document may act as an object placeholder in the system and method described above.

In a preferred embodiment, the storage of approved pixmap(s) 114 and any associated data may be as collated pages in the form of an electronic document such as a PDF or TIFF file, so that the exact copy(s) of the approved information may be easily archived and later presented as evidence when required.

The composite document 101 may have been originally obtained by being uploaded by the said end user using said device means or have been provided to the server 100 by another person or process. It should be understood that server 100 may be one or more servers acting in a cluster or as micros services or other server configuration known to the art.

In another embodiment, one or more online document controls, such as an “Agree” button 113 may be included as part of a screen page pixmap 112. (In this case a image map or the like could be used to capture user's consent as a mouse click on the button for example.)

In a preferred embodiment, screen image pages may be made to partially scroll or be partially displayed automatically so the context of an online field, control or widget may be preserved. For example, if a user activates a text field overlaid in the top-quarter of a screen image page, it may be scrolled so that part of the previous screen image page becomes visible (with matched zoom level, or scaled such as so the whole previous screen image page can be seen) as a “context page”. These arrangements allow any instructions to end users represented in the previous screen image page to be viewed at the same time as the nearby online field, control or widget. Optionally, a calculation may have already been performed on a server to determine how much the scroll should be, such as enough for the paragraph previous to the online input field, control or widget and included as one of the properties. Once end user input has been obtained, or the end user changes the zoom, or or the user navigates or is taken to another screen image page, the context page is removed from view.

In a preferred embodiment, a user may be shown previously approved material for re-approval if subsequent end user input changes or a validation or other process changes what was previously approved. For example, consider the case where pagination of the original composite document has been done to a uniform page size: If a group of overlaid radio (option) buttons spans several screen page pixmaps, and a user selects one option on one page but changes their mind to select an option on the next, the system may take the user back to re-approve the previous page where the former selection would appear as deselected. A more complex scenario might be where relationships between end user inputs has been created using programming scripts, or standard actions where a checkbox if selected may require a previous or other overlaid field to be filled if not already filled. Thus if logically-related overlaid controls span several displays of pixmaps, and user input alters one control which alters the data of another that was overlaid on another pixmap, the user may be presented previous pixmap(s) for re-approval.

In another embodiment, the invention may repaginate a composite document before rasterisation to break the approval process into stages. The size of the pages may vary according to the intended display size of the device and the number of columns to be displayed. For a single column display in particular, page lengths may vary so as to contain enough space for groups of related inputs, such as radio (group option) buttons. Page lengths may also be varied to include an online text field, control or widget in the context of the paragraph above.

In order to save end users of a device being presented with irrelevant information or choices, in a preferred embodiment, the composite document may be dynamically created or used in conjunction with other documents depending on user input. Further or alternatively, small pixmap forms (comprising a pixmap with one or more overlays) may be created in advance to be added to a screen image page depending on user input.

It will be appreciated that an associated group of input fields, placeholders or input controls in a composite document may be of mixed types. For example, it is often the case that the last option of a group of radio buttons in a composite document may be labeled “Other”, where no other option applies. For this case an associated text filed nearby may allow an end user to specify what that “Other” option if selected would refer to. As previously mentioned, embodiments of the invention may preserve that association using a context page, a plurality of scrolled pages approved as unit, or pagination where all associated inputs fall on the same page. However in many situations scrolling pages approved as a unit will involve the least processing and the simplest presentation.

In a preferred embodiment, on small devices with insufficient space for an end user to read what is being inputted or operate the device's features such as copying and pasting, a dialog box may be overlaid upon the screen image page to capture the user input when an input field, control or widget obtains the end user's focus—e.g. is touched. Further or alternatively the overlaid dialog may be manually triggered by a device's end user, by for example double-clicking or tapping twice on a an input field, control or widget.

### BRIEF DESCRIPTION OF FIGURES

The figures provided herein are to assist the understanding of the invention and are not intended to limit the invention to any particular embodiment. Briefly:

FIG. 1 illustrates the method described above. Note the object placeholder 108 need not always be larger than the input widget overlaid, however it is shown thus to be clearly seen for illustrative purposes. Optionally, when user input 107 is updated 110 analysis 102 and/or discernment of properties 103 and/or placeholder substitution 104 may be skipped, with the updated composite document or part thereof preceding directly to rasterisation 105.

FIG. 2 is a flow diagram describing a particular implementation of composite document pre-processing, analysis and rasterisation.

FIG. 3 is a diagram describing how end user interaction in relation to pixmap forms may be handled in a particular implementation.

### FURTHER DESCRIPTION

This following detailed description is not intended to limit the invention to a particular configuration or implementation style but to further explain the principles by which it may operate by way of example:

In a micro services architecture it may be appropriate to implement the invention by way of two server services communicating with an end user device means, such as a Web browser.

An end user viewing and interaction service “UX” may be implemented to hold user state logic. This may be implemented using a Web app development tool such as Xojo Web Edition by Xojo Inc. This provides a “low code” properties, methods and events programming similar to desktop application tools. In one embodiment UX is a web-server that is stateful and is responsible for sending information to a viewer's web-browser and logging in real time the actions of the viewer. UX service also handles form filling.

Another rasteriser-analyiser service “RA” may assist UX by extracting any form field properties or placeholder properties for widgets. For example, the placeholder for a signature may be “/ /” or the underlined portion of the string “Signed: ______”. On the other hand, a placeholder may be an empty box graphic whose name included “Drawing”, in which case RA will consider it to be space 395 assigned for the user to draw. “______” may be construed as a placeholder for a “DatePicker” widget to obtain a date for insertion in that place. Properties may include coordinates of where the field or control should lie on the page, default values, colours or indications of behavior to be communicated to UX and/or ultimately the user's Web browser. For example, RA may also detect if a textural placeholder such as “______” (which it may consider as warranting a text input field) has an asterix next to it so as to make such a field mandatory field upon conversion by recording the author's intention as a property. It will be appreciated these examples given are illustrative and not intended to limit the invention but to explain the principles upon which many types of fields and/or controls may be detected, analysed and recorded.

RA also rastserises the composite document and makes the pixmap pages available to UX for serving to the Web browser. It may be convenient to have rasterisation and field/control analysis both conducted by RA as this means the composite document only has to be made available once. However it will be appreciated that for long documents these functions may be conducted on different threads by using a helper application for image processing “IP” so that analysis and rasterisation may be performed concurrently to increase speed.

In operation, UX in a preferred embodiment ‘places’ appropriate web controls in the coordinates detected by the RA to allow user interaction. When a user modifies a form object or control (which to avoid doubt, includes adding new data and/or changing data), the input data is stored in the user's session within the UX. This data can be saved as JSON text for example. The way UX may respond to form object modification depends on the type of form object modified. And when a form object or control has been modified, data validation or processing of data may occur before or after such data is communicated to an RA to update a composite document, or both before and after.

In one implementation, once a user has finished filling the current displayed pixmap(s) often known as “screen-page(s)” the user may indicate data entry is complete (such as by voice recognition or clicking on a button or gesturing) to trigger rendering of a fully rendered version of the filled screen page(s), or else the system may detect filling has competed to trigger automatic rendering. After viewing the rendering, a user may then confirm satisfaction with the the rendition of the input data by saying so for voice recognition or clicking on a button or gesturing, for example. A user may also request a rendition of screen pages as a PDF file, for printing to complete parts of the form manually for example.

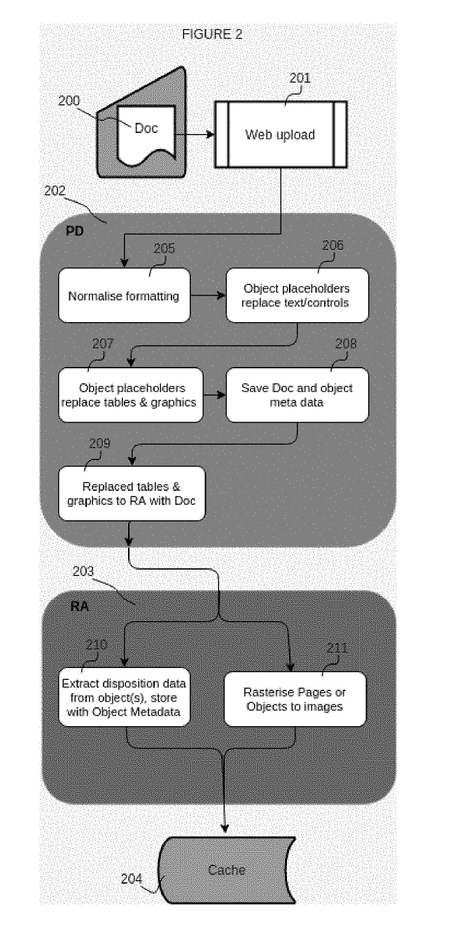

It may be advantageous in some implementations to perform parts of document processing once for all. users of the information, such as when the same information set is to be filled out by multiple parties for example. Turning now to FIG. 2, composite document 200 which may optionally be created by a user and uploaded to the system 201, is transmitted to a pre-format document “PD” routine 202. Formatting is then “normalised” 205 including repagination for the intended output size (including resizing and rearranging graphical objects), plus converting margins, tabs stops etc. to suitable dimensions.

The next step in PD may be to substitute object placeholders in place of textural placeholders and/or controls 206 so as to preserve as much as practicable the composite document's layout by object placeholders being of the same or similar dimensions to what they are substituting. During this step or as a separate step, object placeholders may also replace tables and graphics (including any diagrams or pictures) 207 which may optionally be extracted and preserved separately for later use, such as separate end user manipulation or editing enabled by UX. In such cases object placeholders may be pictures or graphics created to look the same or similar to any of the placeholder text, controls, tables and graphics or part thereof they replace. Next, the modified composite document may be saved with metadata such as the names, number and types of object placeholders relating to each page 208. The final PD step may be to forward a copy of any extracted tables or graphics to RA along with the modified composite document 209.

RA 203 may then obtain placeholder object disposition data 210 for each modified composite document page, or any table or graphic, to add to the relevant metadata, so as to provide enough information for UX in future to overlay appropriate controls or widgets over any spaces reserved by object placeholder(s). (To avoid doubt, the term ‘control’ may refer to a field such a text field email address input field, or a check box or other control known to the art, while widget may refer to a date-picker, or group of spatially or logically-related controls, or database access, video player or other widget.) The modified document page(s) and/or any table or graphic may be rasterised 211 for future display under UX control, with appropriate controls or widgets overlaid according to the metadata. The output from RA 203 may be stored in cache 204 for this purpose.

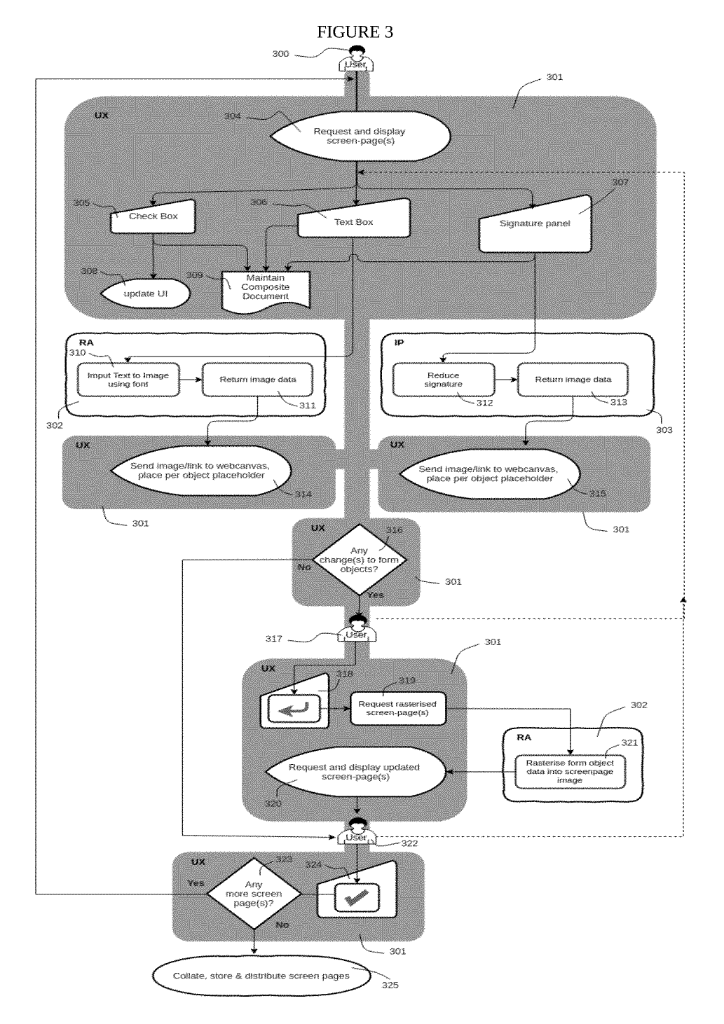

An example of the invention from more of an end user's point of view may be seen in FIG. 3. The end user 300 requests to see information as screen pages 304 such as by clicking on a link in an email or SMS received on their mobile device. The request is passed to UX 301 which then returns one or more pix maps presented to end user 300 as screen page(s) such is in a Web browser. Using metadata associated with the screen page(s), UX 301 causes controls to be overlaid such as for check boxes or radio (group option) buttons 305, or controls or widgets such as for text or combo boxes 306, or an area for signature placement 307. For simple controls, such as check boxes and radio buttons, the overlaid control itself may directly update 308 the user interface to display changes as a result of end user 300 input. However in the case of more complex input such as a fonted text or signature acquisition, the input may be sent to RA 302 or IP 303 respectively. In a preferred embodiment, in all cases end user input is captured by UX 301 so that a composite document may be accurately maintained (either immediately or later in RA for example) with updates.

Where a text box has been entered, the text may be communicated to RA 302 for rasterisation using a font into a pixmap 310, which is then returned to the control or widget maintained by UX 301 or position to overlay 314 on a Web page seen by end user 300. In the case where a hand drawn signature has been digitised by a widget, the digitised data may be sent to IP 303 for processing, such as reducing the size of the signature 312. Then the image of the reduced-sized signature may be returned 313 to UX 301 for appropriately overlaying 315 for display to end user 300. The overlays 314 315 may have associated link data to re-show the overlaid control or widget with their previous input data to allow corrections to be easily made such as previously described.

It will be appreciated the controls or widgets mention are only indicative of those which may be used, in order to show the user interactions and processing returned to the user as a result. Other controls or widgets may well be used in different implementations as the case requires.

If any form object data such as may be associated with check box 305 text box 306 or signature panel 307 (or any other controls or widgets) has been changed by end user 300, end user 317 may either continue to make changes (shown by the dotted line from 317) or indicate data entry for the currently displayed screen page(s) is complete 318. Such indication may be by voice command, pressing a button or by way of gesture etc. Alternatively, UX 301 may automatically determine data entry is complete or completed enough to warrant end user approval. The system may know data entry is complete enough when all or all compulsory fields have been given data for example.

After data entry on a screen page is complete or complete enough, UX 301 may send RA a request to re-raterise all or a relevant part of the composite document after the composite document has been updated with updates captured by UX 301. The relevant of a composite document to be updated and rasterised for example, may be that part represented by those screen page(s) presently displayed to user 317. In a preferred embodiment, this may be achieved by UX 301 passing a reference to composite document with the form object data captured 309 ready for insertion into the composite document.

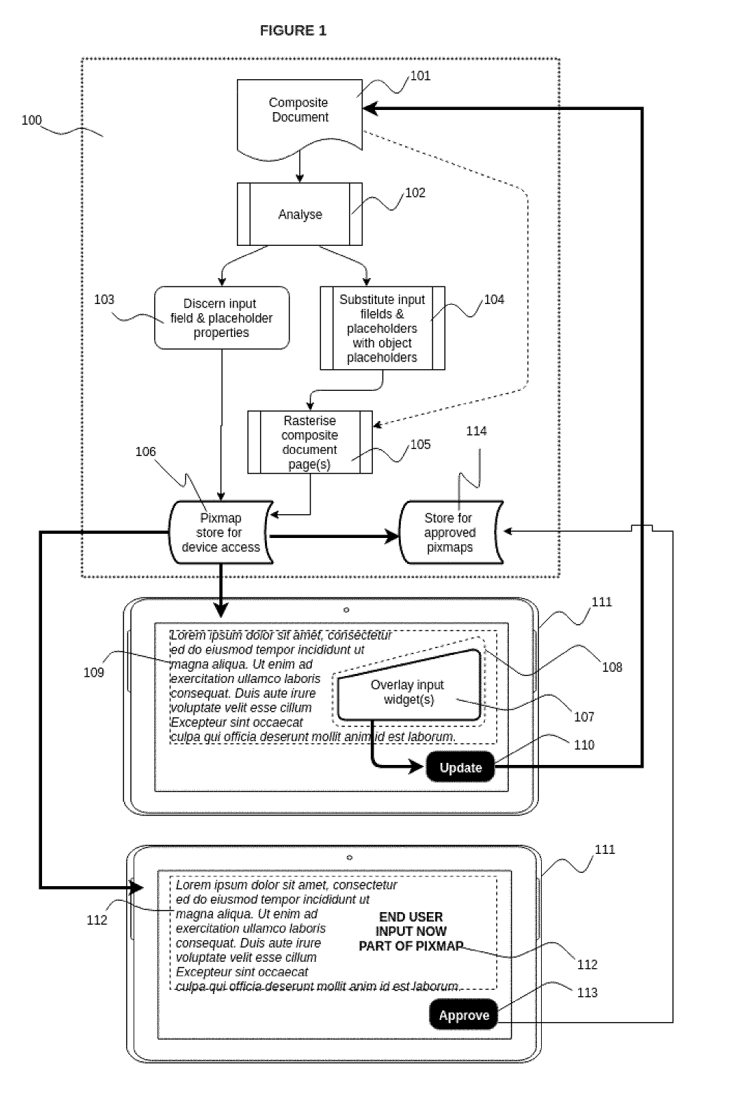

The result of RA 302 rasterising the updated composite document or in preference, a portion thereof 321, is that whole pixmap(s) are produced without any overlays. This is a key aspect of the invention as an end user will be asked to approve an actual copy(s) of the resulting pixmap(s) produced by the system, not a representation of the information reconstructed by the end user's device which may be subject to wide variations. In some embodiments, approval button 113 of FIG. 1 may be included as a control to be rendered in 321.

These updated screen pages may be sent to or requested by UX 301 for possible approval 324 or revision (following then dotted line path in FIG. 3) by end user 322. If end user 322 approves, UX 301 determines if there is any more information for the end user to consider. If not, the approved pixmap(s)—which may be understood by end users to be screen page(s)—may in a preferred embodiment be collated and stored such as in a PDF file for distribution and archiving. The data captured by UX 301 may also be sent to a database or sent on for further processing.

In a preferred embodiment, the resulting PDF file containing approved pixmaps may be fingerprinted using a hash algorithm which may be published to ensure immutability.

It will be appreciated that end users 300 317 322 may be different from each other or all the same person or a combination thereof. If not all the same person, UX 301 may cause end users to be notified and allow access as to the process accordingly.

From all the above it can be concluded that embodiments of the invention will provide end users with both editability of information for convenience and a non-reconstructed form of information for permanency. This is achieved by substituting textural placeholders or controls with (preferably invisible) object placeholder(s) in a composite document to preserve its layout, which composite document is then rasterised into pixmap(s) to eliminate the possibility of any inconsistent presentation. These pixmap(s) representing the composite document are then displayed on the end user's device, with controls or widgets appropriately overlaid in those areas which the rasterisation of object placeholders had the effect of reserving for one or more of them. After end user input into the overlaid controls or widgets has been obtained, such input is correspondingly inserted into the composite document and rasterised into pixmap(s) for end user approval. Corrections may be made by repeating the process, and creation pixmap(s) for approval may progress in context, page by page.

It will be appreciated the descriptions of features described in one embodiment of the invention might well be combined with the features described in another.

The result is improved reliability of IT archives by providing exact copies of what was presented on screen even after end-user modification(s) have been made. The invention may be implemented in such a way as to accept standard word processor documents as input, allow Web presentations for the information to be modified and provide PDF output for archive. In this way the invention can be used to provide better electronic information handling, by improving computer-assisted information presentation, editing and recordation—to, by and for humans respectively. Like ink soaked into the parchment, the invention provides output of each page agreed to by end users (either individually or as a group of pages) as a single piece of data.

1. A system of electronic information-handling comprising at least one or more of each of:
an end user device means operating a program which displays information and is capable of taking input data; and
a composite document containing one or more field(s), placeholder(s) or indicator(s) of where said input data belongs; and
a service program (running on a server or a said user device means) which provides screen images to an end user device means and accepts requests from an end user device means; and
a rasteriser-analyser service program (running on a server or a said user device means) which:
analyses page(s) of said composite document to find the disposition of input fields or placeholders on each page, and records their properties;
also rasterises page(s) of said composite document to create a pixmap “screen page” of each; and
wherein said pixmap(s) are provided to the said end user device means for display; and
wherein said page property records are accessed to create one or more of fields or controls (appropriate to any said placeholders) to overlay upon said pixmap(s) displayed on the display device means; and
wherein if said overlaid field(s) or said overlaid control(s) or placeholders have been modified by an end user or data process, said modified data is communicated to said rasteriser-analyser so that the composite document is updated with said modified data and a new rasterisation is made or the modified data is otherwise melded into or used to replace portion(s) of a pixmap;
wherein the resulting new pixmap is communicated back to said end user device means and displayed there to be approved by an end user; and
wherein if said approval of said end user is ascertained by the system, the said new pixmap is stored (on a server or a said user device means).

2. The system of claim 1 wherein the said rasteriser-analysier substitutes or uses object placeholders in place of input placeholders or fields into said page(s) to reserve space appropriate for overlaying any controls or widgets over screen pages representing the composite document on said end user device;

3. The system of claim 1 wherein said composite document is reflowed after said substitution or use of object placeholder(s) to ensure information is not obscured by an object placeholder.

4. The system of claim 1 wherein a said resulting new pixmap may have field(s)/control(s) re-overlaid to enable the said end user to make correction(s);

5. The system of claim 1 wherein one or more placeholder(s) contain a link to content to be inserted when a composite document is loaded or when information is viewed.

6. The system of claim 1 wherein a screen image pages may be made to partially scroll or be partially displayed automatically by the end user device means so the context of an online field, control or widget may be preserved.

7. The system of claim 1 wherein if logically-related overlaid controls or widgets span several displays of pixmap screen page(s) on the end user device means, and user input alters one control or widget which alters the data of another that was overlaid on a previously displayed pixmap, the display device means presents previous pixmap(s) for said end user's re-approval.

8. The system of claim 1 wherein if an input field, control or widget obtains the end user's focus (e.g. is touched) on a said end user device means but there is insufficient space for reading what is being inputted by the said end user or which has insufficient screen space to operate the device's features such as copying and pasting, then a dialog box is overlaid upon the screen image page (and any other overlay) to capture the user input.

9. A method of electronic information handling that includes the steps of:
obtaining a composite document containing field(s) or placeholder(s) for data input control(s) such as signature panels, date pickers or other input widgets, or both field(s) and placeholder(s); then afterwards
analysing 102 page(s) of said composite document to find the disposition of input fields or placeholders on each page and recording properties (e.g. image map(s) and other information) of these; then afterwards
substituting 104 any object placeholders for corresponding to input placeholders or fields into pages of said composite document; and
rasterising 105 each page of said composite document 101 to create a pixmap(s) of each, in preference with said input fields or placeholders or object placeholders not being visible; then afterwards
providing copies 106 of said pixmap pages(s) and said properties for display on a device means to at least one end user; then afterwards
using said properties to create one or more of fields/controls/widgets as appropriate to any object placeholders 108, to overlay upon said pixmap(s) to be displayed on the display device means; then afterwards
checking to see if any data in said overlaid field(s) or said overlaid control(s) has been modified on a display device means; then afterwards
updating said composite document with any modified data, and re-rasterising to create one or more updated pixmaps or otherwise melding modified data into a pixmap(s) or replacing portions of a pixmap(s) to create an one or more updated pixmaps;
transferring a copy of the updated pixmap(s) via a computer network to a server or an end user device; then afterwards
displaying copy of any updated pixmap(s) on said end user device means to be approved by said end user; then afterwards
if said approval is given by said user, storing approved pixmap(s).

10. The method of claim 9 whereby the said checking step is replaced by a checking step to see if a said field, control, widget or placeholder has been modified by another user's input or by a verification, validation or other process, either with or without the said end user's input.

11. The method of claim 9 with the additional step of reflowing said composite document before said rasterisation to thus provide space appropriate for rendering filed(s), control(s) or widget(s) on an end user device means corresponding to said object placeholders;

12. The method of claim 9 with the additional step before said approval of re-overlaying any said field(s)/control(s)/widget(s) if the corresponding area(s) have been selected by said end user to enable that end user to make correction(s).

13. The method claim 9 whereby with the step of automatically partially scrolling a pixmap or partially displaying pixmaps on end user device means so the context of an online field, control or widget may be preserved.

14. The method of claim 9 with the additional step of when an input field, control or widget obtains the end user's focus (e.g. is touched) on a said end user device means, which has insufficient space for reading what is being inputted by the said end user or which has insufficient screen space to operate the device's features such as copying and pasting, then a dialog box is overlaid upon the screen image page (and any other overlay) to capture the user input.

15. The method of claim 9 whereby if logically-related overlaid fields, controls or widgets span several displays of pixmap(s), and end user input alters one control which alters the data of another that was overlaid on another pixmap not being displayed, the user is presented previous pixmap(s) for re-approval.
